(19) United States
(12) Patent Application Publication
(10) Pub. No.: US 2003/0098061 A1
(43) Pub. Date: May 29, 2003

(54) System and device for condensation management in an airconditioning system

(76) Inventor: Charles Stuchlik III, Tucson, AZ (US)

Correspondence Address: Steven Thrasher, 391 Sandhill Dr., Richardson, TX, 75080, US

(21) Appl. No.: 10/006,446

(22) Filed: Nov. 28, 2001

(51) Int. Cl. F16T 1/20

(52) U.S. Cl. 137/192

(57) ABSTRACT

The invention is generally a condensate trap for an air conditioning system. The condensate trap includes a first end cap having a first ear and a second ear, a second end cap having a first ear and a second ear, a chamber that couples the first end cap to the second end cap, and a float disposed in the chamber.

### TECHNICAL FIELD

Generally, the invention relates to air conditioning systems such as air conditioners, or heat pumps, and more particularly, the invention relates to systems and devices that manage condensation disposal for an air conditioning system.

### STATEMENT OF A PROBLEM ADDRESSED BY THIS INVENTION

Air conditioning systems, such as air conditioners and heat pumps, produce condensation about cooling-coils, particularly in high-humidity environments. Typically, the condensation is trapped and drained away from the air conditioning system via a condensate trap and a drain. A condensate trap prevents the escape of air from an air-conditioned facility by controlling the transfer of air between an air conditioning system and an external atmosphere. In addition, a condensate trap traps condensation and foreign material, such as dust, and allows the condensation and foreign material collected in the trap to be safely removed from the air conditioning system.

It is important for condensate traps to reliably perform because if a drain becomes clogged with dust or other matter, then the condensation cannot escape the air conditioning system, and water damage may occur in and about the air conditioning system. Therefore, it is desired to provide a condensate trap that is clog-resistant. In addition, should a condensate trap become clogged, the system may be stuck “open”. An open system allows air to flow freely between the air-conditioned environment and the outside environment, which results in an inefficient air conditioning system.

In addition, some condensate traps use O-rings. O-rings add complexity to the condensate trap, increase the cost of production of condensate traps, are often unreliable, and often only moderately effective. For example, an O-ring may fail at its “seat” (the hole) or at the seal between the O-ring and the body of the condensate trap. An O-ring design also forces inlet-specific and outlet specific end caps, which makes installation difficult and unforgiving. Thus, it would be advantageous to have a system that is not dependent on O-rings.

Furthermore, typical condensate traps are bulky, single-unit structures that are difficult to install and maintain. Accordingly, to overcome these and other disadvantages associated with existing condensate traps, it would be advantageous to provide a drain that reliably provides proper flow, and that is easy to install and maintain.

### SELECTED OVERVIEW OF SELECTED EMBODIMENTS

The invention provides technical advantages as a condensate trap for an air conditioning system. The invention achieves technical advantages by using same end caps type on both the inflow end and the outflow end of the condensate trap, and by connecting the end caps together with an easily removable connecting means, such as a bridle bolt and wing nut, and by gluing a washer into the end caps. Accordingly, the invention provides numerous advantages such as easy installation, repair, and cleaning. In addition, the invention is less costly to manufacture than prior art condensate traps.

In one embodiment the condensate trap includes a first end cap having a first ear and a second ear, a second end cap having a first ear and a second ear, a chamber that couples the first end cap to the second end cap, and a float disposed in the chamber. Other benefits can be obtained by securing the first end cap to the second end cap with a securing means, such as a wing-nut and a threaded bridle bolt, that couples a first ear of the first end cap to a first ear of the second end cap.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a condensate trap for a positive pressure system;

FIG. 2 illustrates a condensate trap for a negative pressure system;

FIG. 3 shows an end-cap for a condensate trap;

FIG. 4a shows a cut-view of the end-cap of FIG. 3 taken along cut-line A-A; and

FIG. 4b shows a cut-view of the end-cap of FIG. 3 taken along cut-line B-B.

### AN EXEMPLARY EMBODIMENT OF A BEST MODE

The invention provides a condensation trap with advantages over existing condensate traps, such as easy installation, repair, and cleaning. In addition, the invention is less costly to manufacture than existing condensate traps. The invention provides these features and benefits by using same end caps type on both the inflow end and the outflow end of the condensate trap, and by connecting the end caps together with an easily removable connecting means, such as a bridle bolt and wing nut, and by gluing a washer into the end caps.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for-functioning-” or “step for-functioning-” in the Claims section.

Description of the Figures

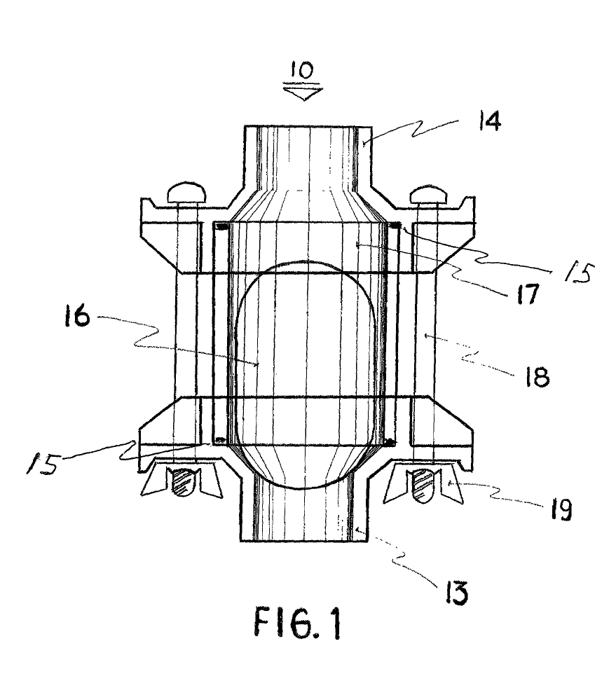

The invention may be embodied in any fashion definable by using the claims, however, better understanding of the invention can be realized by referring to a specific embodiment. Accordingly, FIG. 1 illustrates a condensate trap for a positive pressure system 10 (the condensate trap 10) for an air conditioning system. The condensate trap 10 typically includes a first end cap 14 and a second end cap 13, each end cap 13, 14 has a first ear and a second ear as described below. In one preferred embodiment, the first end cap 14 and the second end cap 13 are substantially similar. This enables a technician, such as a plumber, to carry only one type of end cap, which makes installation less confusing and reduces inventory costs. Preferably, the end caps 13, 14 are transparent to allow the condensate trap 10 to be inspected without requiring the condensate trap 10 to be disassembled.

A chamber 17 couples the first end cap 14 to the second end cap 13. In one embodiment, the chamber 17 is a generally transparent tube. Preferably, the chamber is ultraviolet light resistant to provide a more environmentally resilient condensate trap 10. Each end cap 13, 14 has a sealing ring 15 which sits between the chamber 17 and each end cap 13, 14. The sealing ring 15 can be made of any material that when compressed, forms an airtight seal between the chamber 17 and each end cap 13, 14. A float 16 is disposed in the chamber 17. The float 16 is capable of forming a generally air-tight seal with either the first end cap 14 or the second end cap 13, as described below. For the condensate trap 10 illustrated in FIG. 1, the float 16 is a slug or double-ball, as the condensate trap illustrated in FIG. 1 is for a “positive” air conditioning system.

The first end cap 14 is secured to the second end cap 13 with a securing means that is illustrated in FIG. 1 as a wing-nut 19 and a threaded bridle bolt 18 combination. In an alternative embodiment, the securing means is a bolt 18 and nut 19 combination. However, it should be understood that any securing means that reliably couples the end caps is an alternative securing means. Preferably, to enable weather and environmental resilience, the securing means is made of a weather resistant material, such as a petroleum-based material.

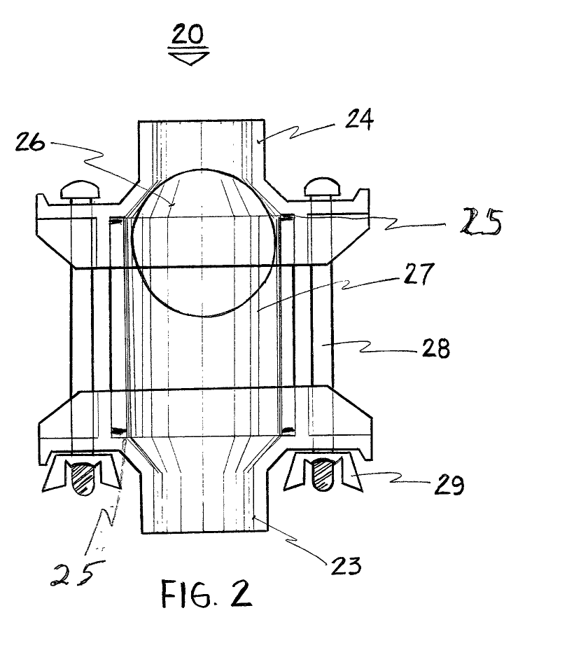

While FIG. 1 illustrates a condensate trap adapted for use by a positive pressure air conditioning system, FIG. 2 illustrates a condensate trap for a negative pressure system 20. Similar to the positive pressure system 10, the negative pressure system 20 has a first end cap 24 and a second end cap 23 which are coupled to each other by a chamber 27. Each end cap 23, 24 has a sealing ring 25, and the first end cap 24 is connected to the second end cap 23 with a securing means that includes a bridal-bolt 29 and a wing nut 28. Similar to the condensate trap 10 for the positive system, the condensate trap 20 for the negative system has a float 26 disposed in the chamber 27, where the float 26 capable of forming a generally air-tight seal with either the first end cap 24 or the second end cap 23. However, in a negative system, the float 26 is preferably a ball, as illustrated in FIG. 2.

FIG. 3 shows an end-cap 30 for a condensate trap, which may be used with either the positive system's condensate trap 10 or the negative system's condensate trap 20. The end cap 30 has a first ear 32 and a second ear 34, however, it should be understood that the end cap 30 may have any number of ears or other means for attaching a securing means to the end cap 30. Each ear 32, 34 includes a catch 31, 33 and hole 36, 38 combination. The end cap 20 also has a throat 39 that is size and shape selected so the throat 39 will be attachable to a pipe or other condensate disposal means.

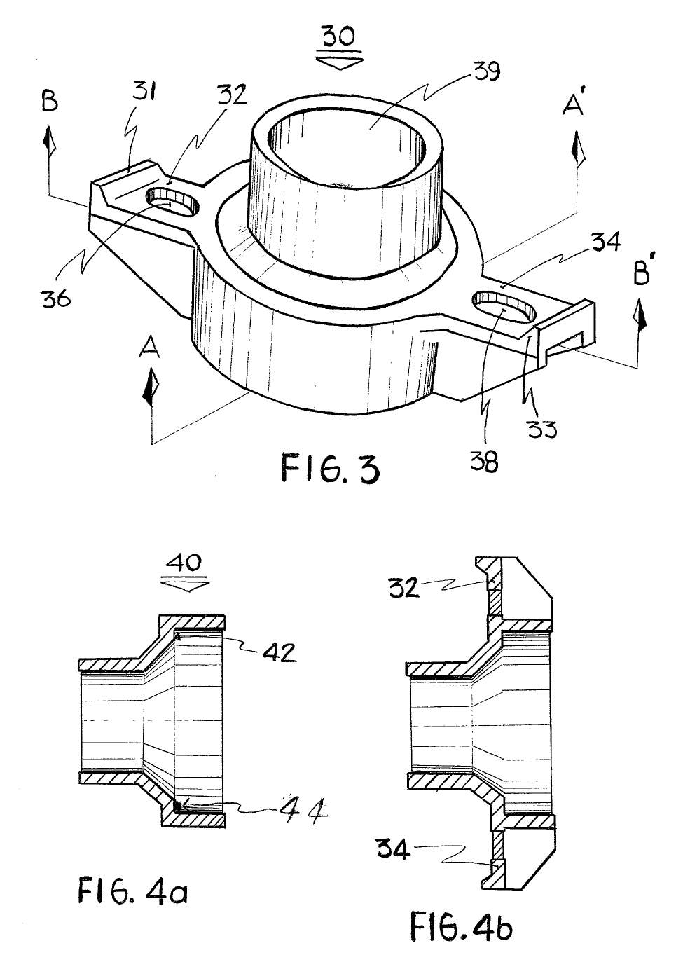

FIG. 4a shows a cut-view of the end-cap of FIG. 3 taken along cut-line A-A. Any lines that show ears have been removed to minimize confusion. The end cap 30 comprises a seat 42 that is integrally molded with the end cap, the seat comprising the area of the end-cap capable of receiving a sealing ring 44. In a preferred embodiment, the sealing ring 44 is attached to the end cap 40 with an adhesive. The sealing ring 44 seals a tube to an end cap. FIG. 4b shows a cut-view of the end-cap of FIG. 3 taken along cut-line B-B. FIG. 4b particularly shows a configuration of the end cap ears 32, 34. In practice, a securing means couples a first ear of a first end cap to a first ear of a second end cap.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I Claim:

1. A condensate trap for an air conditioning system, comprising:
a first end cap having a first ear and a second ear;
a second end cap having a first ear and a second ear;
a chamber that couples the first end cap to the second end cap; and
a float disposed in the chamber, the float capable of forming a generally air-tight seal with either the first end cap or the second end cap.

2. The condensate trap of claim 1 wherein the first end cap is secured to the second end cap with a securing means that couples a first ear of the first end cap to a first ear of the second end cap.

3. The condensate trap of claim 2 wherein the securing means is a nut-and bolt combination.

4. The condensate trap of claim 2 wherein the securing means comprises a wing-nut and a threaded bridle bolt.

5. The condensate trap of claim 4 wherein the threaded bridle bolt is made of a petroleum based material.

6. The condensate trap of claim 1 wherein the first ear of the first end cap comprises a catch-and-hole combination.

7. The condensate trap of claim 1 wherein the chamber is a generally transparent tube.

8. The condensate trap of claim 1 wherein the first end cap comprises a seat that is integrally molded with an end cap.

9. The condensate trap of claim 1 wherein the second end cap comprises a seat that is integrally molded with an end cap, and further comprises a sealing ring disposed upon the seat.

10. The condensate trap of claim 1 wherein the first end cap is generally transparent.

11. The condensate trap of claim 1 wherein the float is a slug.

12. The condensate trap of claim 1 wherein the float is a ball.

13. The condensate trap of claim 1 further comprising a seat integrally molded into the first end cap.

14. The condensate trap of claim 1 further comprising a seat integrally molded into the second end cap.

15. The condensate trap of claim 1 wherein the first end cap and the second end cap are substantially similar.

16. The condensate trap of claim 1 wherein the chamber is ultraviolet light resistant.

17. A condensate trap for an air conditioning system, comprising:
a first end cap having a first ear and a second ear;
a second end cap having a first ear and a second ear;
a chamber that couples the first end cap to the second end cap;
wherein the first end cap is secured to the second end cap with a securing means that couples a first ear of the first end cap to a first ear of the second end cap; and
a float disposed in the chamber, the float capable of forming a generally air-tight seal with either the first end cap or the second end cap.

18. The condensate trap of claim 17 further comprising a seat integrally molded into the first end cap.

19. The condensate trap of claim 17 wherein the securing means comprises a wing-nut and a threaded bridle bolt.
